(19) United States
(12) Patent Application Publication
(10) Pub. No.: US 2006/0012261 A1
(43) Pub. Date: Jan. 19, 2006

(54) Stator for electrical motor

(75) Inventors: Chin-Long Ku, Tu-Cheng (TW); Chin-Wen Yeh, Tu-Cheng (TW); Chia-Mou Liu, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: Foxconn Technology Co., Ltd, Tu-Cheng City (TW)

(21) Appl. No.: 11/135,592

(22) Filed: May 23, 2005

(30) Foreign Application Priority Data
Jul. 16, 2004 (CN) 200410028181.5

(51) Int. Cl. H02K 7/00; H02K 11/00; H02K 3/34; H02K 1/12; H02K 3/46

(52) U.S. Cl. 310/215; 310/254; 310/67 R

(57) ABSTRACT

A stator (1) includes a stator core (10) and an insulating member (12) attached to the stator core. The stator core includes a first engaging structure. The insulating member includes portions to cover the stator core, thereby insulating the stator core from stator coils, and a first engaging structure other than said portions. The first engaging structure engages with the second engaging structure to interconnect the stator core and the insulating member. According to a preferred embodiment, the first engaging structure includes a plurality of mounting holes (108), and the second engaging structure includes a plurality of mounting protrusions (124) engaged in the mounting holes respectively.

### TECHNICAL FIELD

The present invention relates generally to electrical motors, and more particularly to a stator of such a motor.

### BACKGROUND

Electrical motors have been widely used to transfer electrical energy to mechanical energy in a form of rotational motion. For example, in a heat-dissipating fan, an electrical motor is used to drive fan blades to rotate therewith, thereby generating airflow toward heat-generating components.

The electrical motor usually includes a stator and a rotor rotatable with respect to the stator. Referring to FIG. 4, such a stator 1′ typically includes a stator core 10′ having a plurality of winding slots for receiving stator coils (not shown) therein. To avoid the coils to electrically contact the stator core 10′, upper and lower insulating frames 12′, 14′ are used to cover the stator core 1′ and electrically insulate the stator coils from the stator core 10′.

The upper and lower insulating frames 12′, 14′ respectively form a plurality of flanges 102′, 104′ extending from edges thereof. These flanges 12′, 14′ extends into the winding slots to cover the stator core 10′. On the other hand, these flanges 102′, 104′ engage with the stator core 10′ at the winding slots, thereby serving as positioning the upper and lower insulating frames 12′, 14′ to the stator core 10′.

Since the upper and lower insulating frames 12′, 14′ are generally made of plastic material and there lacks a reliable mechanism to firmly interconnect the frames 12′, 14′ with the stator core 10′, the insulating frames 12′, 14′ may deform or separate from the stator core 10′ during operation of the motor, and thus fail to completely insulate the stator coils from the stator core 10′, which in turn may result in an undesired electrical connection between the stator core 10′ and the stator coils. This will be more likely to occur especially when the electrical motor is used in situations where a lot of shocks or vibrations exist. Therefore, a heretofore unaddressed need exists in the industry to address the aforementioned deficiencies and inadequacies.

### SUMMARY OF THE INVENTION

The present invention provides a stator for an electrical motor. The stator comprises a stator core and an insulating member attached to the stator core. The stator core comprises a first engaging structure. The insulating member comprises portions to cover the stator core, thereby insulating the stator core from stator coils, and a first engaging structure other than said portions. The first engaging structure engages with the second engaging structure to interconnect the stator core and the insulating member. According to a preferred embodiment, the first engaging structure comprises a plurality of mounting holes, and the second engaging structure comprises a plurality of mounting protrusions engaged in the mounting holes respectively.

Other systems, methods, features and advantages of the present invention will be drawn from the following detailed description of the preferred embodiments of the present invention with attached drawings, in which:

### BRIEF DESCRIPTION OF THE DRAWINGS

FIG. 1 is an isometric, exploded view of a stator according to a preferred embodiment of the present invention;

FIG. 2 is similar to FIG. 1, but viewed from another aspect;

FIG. 3 is an assembled view of the stator of FIG. 1; and

FIG. 4 is an isometric, exploded view of a conventional stator.

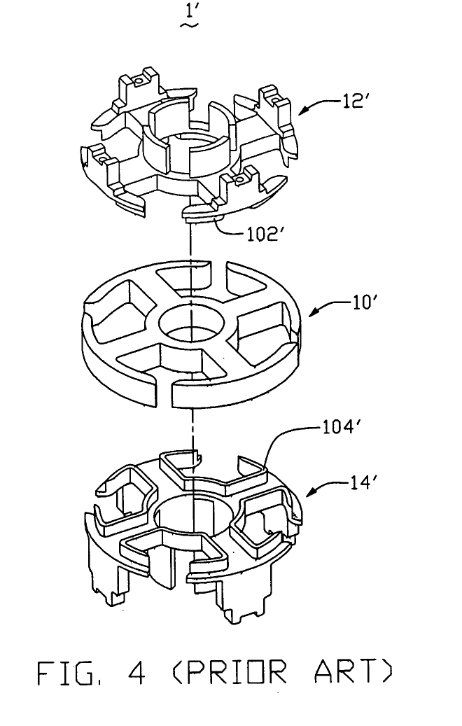

### DESCRIPTION OF PREFERRED EMBODIMENT

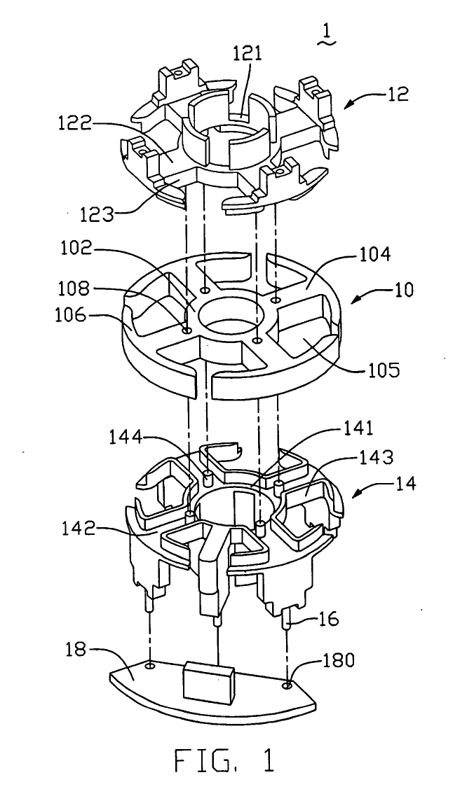

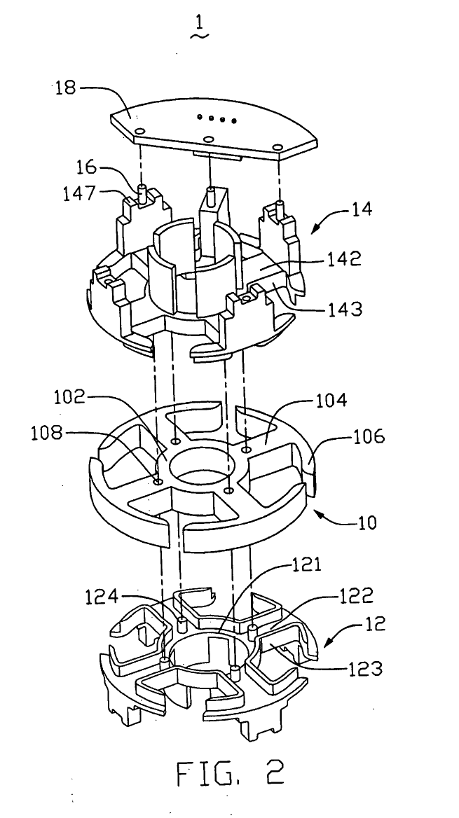

FIGS. 1 and 2 show a stator 1 of a motor in accordance with a preferred embodiment of the present invention. The stator 1 comprises a stator core 10, upper and lower insulating frames 12, 14 for being attached to top and bottom sides of the stator core 10 respectively, and a PCB 18 (Printed Circuit Board) for being attached to the lower insulating frame 14. For the sake of simplicity, the stator coils of the stator 1 are omitted.

The stator core 10 may comprise a plurality of laminated silicon steel sheets. The stator core 10 comprises a center portion 102, and four generally T-shaped pole members 104 extending radially and outwardly from the center portion 102. Each pole member 104 has an arc-shaped wing 106 formed at its free end. Every two adjacent pole members 104 and a part of the center portion 102 cooperatively form a winding slot 105 therebetween for receiving a corresponding stator coil therein. Alternatively, the stator core 10 may form more than or less than four pole members 104 according to practical needs. A plurality of mounting holes 108 is defined through the stator core 10 around the center portion 102 thereof.

The upper insulating frame 12 comprises a center portion 121 corresponding to the center portion 102 of the stator core 10, and four generally T-shaped extensions 122 formed around the center portion 121 corresponding to the pole members 104 of the stator core 10 respectively. The center portion 121 and the extensions 122 form a plurality of flanges 123 at edges thereof. These flanges 123 extend into the winding slots 105 of the stator core 10, respectively, when the upper insulating frame 12 is attached to the top side of the stator core 10.

As can be better seen in FIG. 2, a plurality of mounting protrusions 124 is formed on a bottom surface of the upper insulating frame 12, for extending into the mounting holes 108 of the stator core 10 respectively when the upper insulating frame 12 is attached to the topside of the stator core 10.

The lower insulating frame 14 generally has the same configuration as the upper insulating frame 12. The lower insulating frame 14 also has a center portion 141 and four generally T-shaped extensions 142 formed around the center portion 141. Flanges 143 extend from edges of the center portion 141 and the T-shaped extensions 142. The lower insulating frame 14 forms a plurality of mounting protrusions 144, for extending into the mounting holes 108 of the stator core 10 when the lower insulating frame 14 is attached to the bottom side of the stator core 10.

Each extension 142 forms downwardly toward the PCB 18 a leg 147. Three positioning pins 16 extend downwardly from the legs 147 toward the PCB 18, and the PCB 18 defines three positioning holes 180 for receiving the positioning pins 16 therein, thereby attaching the PCB 18 to the lower insulating frame 14.

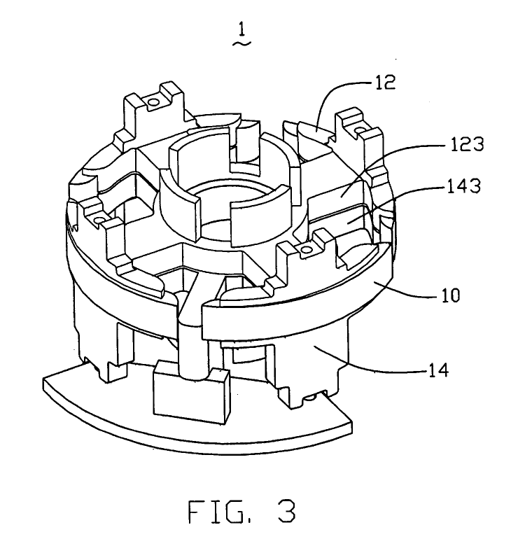

Referring to FIG. 3, in assembly of the stator 1, the upper insulating frame 12 is placed upon the top side of the stator core 10, with the mounting protrusions 124 aligned with the mounting holes 108 of the stator core 10 respectively. The upper insulating frame 12 is then pressed against the stator core 10, so that the mounting protrusions 124 are engagingly received in the mounting holes 108 respectively. The upper insulating frame 12 is thus assembled to the top side of the stator core 10. Simultaneously, the flanges 123 extend into the winding slots 105 to surround upper portions of the winding slots 105 and cover upper portions of side surfaces of the stator core 10 facing the winding slots 105.

In substantial the same manner, the lower insulating frame 14 is assembled to the bottom side of the stator core 10, with the mounting protrusions 144 engagingly received in the mounting holes 108 and the flanges 143 covering lower portions of the side surfaces of the stator core 10 facing the winding slots 105.

Finally, the positioning pins 16 of the lower insulating frame 14 are engaged into the positioning holes 180 of the PCB 18 to attach the PCB 18 to the lower insulating frame 14.

In the stator 1 of the preferred embodiment of the present invention, the upper and lower insulating frames 12, 14 respectively cover top and bottom portions of the stator core 10. The upper and lower insulating frames 12, 14 form the mounting protrusions 124, 144 engaging into the mounting holes 108 of the stator core 10. This configuration enhances interconnection strength and reliability of the upper and lower insulating frames 12, 14 with the stator core 10. Possibility of deformation of the upper and lower insulating frames 12, 14 is reduced and an overall integrity of the stator 1 is thus improved.

In the stator 1 according to the preferred embodiment of the present invention, the mounting holes 108 are defined through the stator core 10, and the mounting protrusions 124, 144 extend into the mounting holes 108 respectively from opposite top and bottom ends thereof. Alternatively, a plurality of blind holes may be defined in the stator core 10 at opposite top and bottom sides thereof, for respectively receiving the mounting protrusions 124, 144 of the upper and lower insulating frames 12, 14.

In addition, in the preferred embodiment of the present invention, the mounting holes 108 are formed in the stator core 10, and the mounting protrusions 122, 144 are formed on the upper and lower insulating frames 12, 14. Alternatively, the mounting holes may be defined in the upper and lower insulating frames, while the mounting protrusions may be formed on the stator core.

Further, in the preferred embodiment of the present invention, the mounting protrusions 124, 144 are shaped in a form of posts. The mounting protrusions, however, may be embodied in other forms such as, for example, in a form of bumps, clips.

It is understood that the invention may be embodied in other forms without departing from the spirit thereof. The above-described examples and embodiments are to be considered in all respects as illustrative and not restrictive, and the invention is not to be limited to the details given above.

1. A stator for an electrical motor, comprising:
a stator core comprising a center portion, and a plurality of pole members extending integrally and outwardly from the center portion, the stator core defining a plurality of round mounting holes therein; and
upper and lower insulating frames located at opposite sides of the stator core, the upper and lower insulating frames respectively forming a plurality of extensions corresponding to the pole members of the stator core, and a plurality of round mounting protrusions engaged into the round mounting holes to position the upper and lower insulating frames to the stator core.

2. The stator of claim 1, wherein the mounting holes are arranged around the center portion of the stator.

3. The stator of claim 1, wherein the mounting holes are defined through the stator core.

4. The stator of claim 1, wherein the mounting holes are blind holes defined at the opposite sides of the stator core.

5. The stator of claim 1, wherein the stator core defines a plurality of winding slots between two adjacent pole members, and the upper and lower insulating frames respectively form a plurality of flanges extending into the winding slots to cover the pole members.

6. The stator of claim 1, further comprising a printed circuit board attached to the lower insulating frame.

7-11. (canceled)

12. A stator for a motor, comprising:
an integral stator core made of laminated silicon steel sheets, having a center portion, a plurality of pole members extending integrally and outwardly from the center portion and cooperating therewith to define a plurality of winding slots each adapted for receiving a stator coil therein, and a first engaging structure formed on the stator core around the center portion thereof; and
an insulating frame having flanges extending into the winding slots adapted for insulating the stator coils from the stator core and second engaging structure, the second engaging structure engaging with the first engaging structure to enhance the interconnection between the stator core and the insulating frame,

13. The stator of claim 12, wherein the first engaging structure comprises a round hole and the second engaging structure comprises a round protrusion engaging in the round hole.

14. The stator of claim 13, wherein the round hole is formed adjacent a junction of the center portion and a respective pole member.

15. The stator of claim 12, wherein the first engaging structure comprises round a protrusion and the second engaging structure comprises a round hole engagingly receiving the round protrusion.

16. A stator for an electrical motor, comprising:
a stator core having a center portion, and a plurality of pole members extending integrally and radially from the center portion, the pole members cooperating therewith to define a plurality of winding slots each adapted for receiving a stator coil therein;
a first engaging structure formed on the stator core around the center portion thereof;
an insulating member attached to the stator core, the insulating member comprising portions to cover the stator core to space the stator core from the stator coil, and a second engaging structure other than said portions, the second engaging structure engaging with the first engaging structure to prevent both circumferential and radial movement of the stator core with respect to the insulating member.

17. The stator of claim 16, wherein one of the first and second engaging structures is a round protrusion, and the other of the first and second engaging structure is a round hole engagingly receiving the round protrusion therein.

18. The stator of claim 17, wherein the pole members extend outwardly on the center portion and are located at outer circumferential side of the stator core for interaction with a rotor of the motor.

19. The stator of claim 17, wherein the first engaging structure is formed at junctions of the pole members and the center portion.

20. The stator of claim 16, wherein the stator core is integral.
